(19) United States
(12) Patent Application Publication
(10) Pub. No.: US 2010/0253633 A1
(43) Pub. Date: Oct. 7, 2010

(54) FINGERTIP TACTILE-SENSE INPUT DEVICE

(75) Inventors: Takuro Nakayama, Tokyo (JP); Shimpei Miyata, Tokyo (JP); Atsuhide Yoshida, Kanagawa (JP)

Correspondence Address: HARTMAN & HARTMAN, P.C., 552 EAST 700 NORTH, VALPARAISO, IN, 46383, US

(73) Assignee: I'M CO., LTD., Fukuoka (JP)

(21) Appl. No.: 12/670,752

(22) PCT Filed: Jul. 25, 2008
(86) PCT No.: PCT/JP2008/063919

§ 371 Date: Jun. 3, 2010

(30) Foreign Application Priority Data
Jul. 26, 2007 (JP) 2007-194661

(51) Int. Cl. G06F 3/02

(52) U.S. Cl. 345/169

(57) ABSTRACT

To provide a fingertip tactile-sense input device in an input device having a plurality of keys within an extremely small range such as within a range of person's fingertip movement, which while being made extremely small and thin, enables key input while maintaining a sufficient click feeling, and also which is excellent for mass production. A base plate (50) has one dome spring (51) arranged at an approximate center of a side of a hole space, and a contact structure (52) on an inside of the dome spring (51). A surface sheet (20) is fixed to a flange (11) so that in a free state, this becomes approximately the same level as an other face of a frame (10), and is provided with a plurality of surface protrusions (21) deployed within a range in which the person's fingertip moves, and has flexibility, elasticity, and pliability. A digitizer (30) is arranged on the hole space side of the surface sheet (20), so as to be slidable on the surface sheet (20), and is capable of electrically measuring a position where a force applied to the surface sheet (20) is the strongest. A convex part (41) is provided on an actuator (40), and the actuator (40) is fixed to the digitizer (30), and has rigidity.

The present invention relates to a fingertip tactile-sense input device used in a personal digital assistant including a cellular telephone, or in compact electronic equipment such as a remote controller, a portable audio player, a mouse, an electronic notebook, a gaming device, or a medical device, that uses the touch of a fingertip to input numbers or characters, or pattern or position information.

### BACKGROUND OF THE INVENTION

Presently the popularization of personal digital assistants is remarkable, and the use of small size terminals such as cellular telephones, not only for conventional telephone conversation, but also for communication involving input of characters and symbols used for email and the like, and exchange of interactive information via the Internet is becoming more frequent.

However, in conventional key input, the key input device is configured centered on key buttons corresponding to number buttons in a conventional telephone, resulting in a limitation to miniaturization of the device. Furthermore, when inputting characters, character keys are assigned to each numeric key of the relevant key button, so that irrespective of whether the language is English or Japanese or the like, when selecting, inputting, and confirming the character, it is necessary to operate the key many times.

In such compact electronic equipment, miniaturization is demanded, and as an input device used for a personal digital assistant or the like, there has been developed a fingertip tactile-sense input device that is provided with a plurality of switches in a region in which a person's fingertip can move, and that makes one of each conductive state of a switch selected by information processing, input information. As such a fingertip tactile-sense input device, in Japanese Patent No. 3,708,508 (U.S. Pat. No. 7,280,101, WO 03019373), there is disclosed technology that provides a plurality of conducting contact points, and selects and processes input information.

The operator feels by touch, surface protrusions or the like provided on an input plate of the fingertip tactile-sense input device, and so as to be able to provide desired input information, moves a force input center of a fingertip within a range in which a person's fingertip moves to select the input information, and then presses the surface protrusion until a switch arranged inside corresponding to each surface protrusion works, to thereby confirm the input information. As a result, selection, input, and confirming, of input information by movement of the fingertip becomes possible, enabling realization of a small size, user friendly, and extremely good input device for a personal digital assistant.

However, in such an input device, it is necessary to align the positions of the internally arranged switches and the surface protrusions. Hence there is a problem in that the structure becomes complex, and is not suitable for mass production.

Furthermore, in the case where a large number of dome springs are used for such a device, there is a problem in that the dome spring becomes extremely small, and it becomes difficult to receive a positive click feeling.

In order to solve such problems, an examination has also been made to change the dome spring that is used, to a tact switch (JP Registered ™) or a microswitch. However due to the sizes required for these, it is not possible to make the input device thin, or small size, and hence there is a problem in that these are not suitable for miniaturization of a personal digital assistant.

### [Patent Document 1] Japanese Patent No. 3,708,508

### BRIEF SUMMARY OF THE INVENTION

An object of the present invention is to provide a fingertip tactile-sense input device in an input device having a plurality of keys within an extremely small range such as within a range of fingertip movement, which while being extremely small and thin, enables key input while maintaining a sufficient click feeling, and also which is excellent for mass production.

The fingertip tactile-sense input device according to the present invention comprises: a frame having a hole space opened in the center, and a flange extending from an inner wall surface to the hole space; a base plate which is fixed at a peripheral portion of the hole space, to a side of one face of the frame, or is formed integral with the frame, and forms a bottom face of the hole space; a digitizer arranged inside the hole space, that is smaller than an outline of an inner periphery of the flange, and which can electrically measure an input position by pressure applied to the surface thereof; a rigid actuator that is larger than the outline of the inner periphery of the flange, and is fixed to a bottom face side of the digitizer, and in which a periphery thereof is arranged on a bottom face side of the flange; a switch mechanism provided between the base plate and the actuator, in a central portion of the hole space; and a click mechanism provided between the base plate and the actuator, in a central portion of the hole space, which becomes a fulcrum point for operation of the actuator, and the device is constructed such that in a free state, the switch mechanism is in a non-conductive state, and when the digitizer and the actuator are pressed with a pressing force of a predetermined amount or more in an optional position, the click mechanism operates and the switch mechanism becomes a conductive state.

Preferably there is further provided a surface sheet on a side of an other face of the frame and fixed to the flange, and arranged to cover a surface side of the hole space, and to be slidable on the digitizer. Furthermore, preferably a plurality of surface protrusions corresponding to keys, are provided on a surface of the surface sheet. Moreover preferably the hole space is sealed to be waterproof, drip-proof, or airtight, by the frame, the base plate, and the surface sheet.

Furthermore, preferably the switch mechanism and the click mechanism comprise: a dome spring provided on an approximate center of either one of the base plate and actuator, and having a contact mechanism inside; and a convex part provided on an approximate center of the other of either one of the base plate and actuator, and in a free state, the contact structure becomes a non-conductive state, and when the actuator is pressed with a pressing force of a predetermined amount or more in an optional position, the dome spring imparts a click feeling, and the contact structure becomes a conductive state. Preferably a stroke range of the dome spring is 0.10 mm to 0.30 mm.

More specifically, the fingertip tactile-sense input device of the present invention comprises: a frame having a hole space opened in the center, and a flange extending from an inner wall surface to the hole space; a base plate which is fixed at a peripheral portion of the hole space, to a side of one face of the frame, and which has one dome spring arranged at an approximate center of a side of the hole space, and a contact structure in the interior of the dome spring; a flexible, stretchable, and pliable surface sheet fixed to the flange so that in a free state it becomes approximately the same level as an other face of the frame, and provided with a plurality of surface protrusions deployed within a range in which a person's fingertip moves; a digitizer arranged to a side of the hole space from the surface sheet, and slidable on the surface sheet, that is smaller than an outline of an inside of the flange, and that is capable of electrically measuring a position where a force applied to the surface sheet is strongest; and a rigid actuator provided with a convex part that is dimensioned such that in a free state the contact structure is non-conductive, and in a state where the surface sheet is pressed, the dome spring is pressed, and the contact structure becomes conductive, and that is larger than the outline of the inside of the flange, and is fixed to the digitizer.

In the description of the present invention, the surface sheet is judged to “be” or “have” flexibility, stretchability, and pliability, in the case where this is soft to the extent that it is lightly or easily deformed with the force of a person's finger, and the shape is restored in the free state, and the actuator is judged to “be” or “have” rigidity, in the case where this is hard to the extent that it is not deformed with the force of a person's finger.

Alternatively, the fingertip tactile-sense input device of the present invention may comprise: a frame having a hole space opened in the center, and a flange extending from an inner wall surface to the hole space; a base plate which is fixed at a periphery of the hole space, to a side of one face of the frame; a flexible, stretchable, and pliable surface sheet fixed to the flange so that in a free state it becomes approximately the same level as an other face of the frame, and provided with a plurality of surface protrusions deployed within a range in which a person's fingertip moves; a digitizer arranged to a side of the hole space from the surface sheet, and slidable on the surface sheet, that is smaller than an outline of an inside of the flange, and that is capable of electrically measuring a position where a force applied to the surface sheet is strongest; and a rigid actuator that is larger than the outline of the inside of the flange, and is fixed to the digitizer, and one dome spring is arranged at an approximate center of the actuator on a side of the base plate, and an interior of the dome spring has a contact structure, and on a center of the dome spring or on a center of the base plate there is provided a convex part that is dimensioned such that in a free state the contact structure is non-conductive, and in a state where the surface sheet is pressed, the dome spring is pressed, and the contact structure becomes conductive.

Alternatively, the fingertip tactile-sense input device of the present invention may comprise: a frame having a hole space opened in the center, and a flange extending from an inner wall surface to the hole space; a base plate which is fixed at a side of one face of the frame, to a periphery of the hole space; a flexible, stretchable, and pliable surface sheet fixed to the flange so that in a free state it becomes approximately the same level as an other face of the frame, and provided with a plurality of surface protrusions deployed within a range in which a person's fingertip moves; a digitizer arranged to a side of the hole space from the surface sheet, and slidable on the surface sheet, that is smaller than an outline of an inside of the flange, and that is capable of electrically measuring a position where a force applied to the surface sheet is strongest; and a rigid actuator that is larger than the outline of the inside of the flange, and is fixed to the digitizer,
and one dome spring is arranged at an approximate center of the actuator on a side of the base plate, or at an approximate center of the base plate on a side of the actuator, and has a contact structure between the digitizer and the actuator.

Alternatively, the fingertip tactile-sense input device of the present invention may comprise a hole space enclosed by a flexible, stretchable, and pliable surface sheet which has a plurality of surface protrusions deployed within a range in which a person's fingertip can move, a frame, and a base plate parallel to the surface sheet, and in the hole space, a digitizer slidable on the surface sheet, and that is capable of electrically measuring a position where a force applied to the surface sheet is strongest, and a rigid actuator fixed to a side of the base plate from the digitizer are arranged, and a contact structure which is dimensioned so as to become a non-conductive state in a free state, and to become a conductive state in a state where the surface sheet is pressed, and a dome spring is arranged between the actuator and the base plate.

Compared to heretofore where in order to apply a plurality of contact structures to such a device, a plurality of extremely small size dome springs were necessary; in the fingertip tactile-sense input device of the present invention, this is achieved with one dome spring. Also, the structure and circuits are simple, and therefore mass production is facilitated, and this can be made small size and thin. For reference, the assembly of the flame, flange and base plate having a thickness of not more than 2.6 mm in resin, or of not more than 1.6 mm in metal can be achieved.

Furthermore, with regards to the dome spring, size constraints can be reduced. Moreover even in the case where the center of the surface sheet is pressed with a pressing force of a predetermined amount or more, or even in the case where a part other than the center of the surface sheet is pressed with a pressing force of a predetermined amount or more, an appropriate click feeling can be obtained with substantially the same stroke and evenness, to an extent that there is no sense of incongruity at all.

Furthermore, since the rigid actuator is arranged slidably with respect to the surface sheet, between the operating finger and the dome spring, so that there is no longer the situation as with the conventional technology where the finger can feel the corrugations of the switch or the dome spring, and moreover an appropriate load on the finger operation is obtained, then even when used continuously, this gives good operability without becoming tired.

Furthermore, the whole body can be made waterproof, drip roof, and airtight, and the ingress of liquid, dust, and dirt can be prevented. Therefore high reliability can be obtained. Moreover, since a variety of surface sheets can be combined for one type of digitizer and actuator, it is possible to easily correspond to small quantities in many varieties.

### BRIEF DESCRIPTION OF THE DRAWINGS

FIG. 1 is a sectional view showing an embodiment of a fingertip tactile-sense input device of the present invention.

FIG. 2 is sectional view showing an operation state, in the fingertip tactile-sense input device of FIG. 1.

FIG. 3 is a design drawing of a surface sheet used in FIG. 1.

FIG. 4 is a sectional view showing a different operating state, in the fingertip tactile-sense input device of FIG. 1.

FIG. 5 is a sectional view showing a different embodiment of a fingertip tactile-sense input device of the present invention.

FIG. 6 is a sectional view showing a different embodiment of a fingertip tactile-sense input device of the present invention

FIG. 7 is a sectional view showing a different embodiment of a fingertip tactile-sense input device of the present invention

FIG. 8 is a perspective view showing the fingertip tactile-sense input device of FIG. 7.

FIG. 9 is a sectional view showing a state where a surface sheet is laid on the fingertip tactile-sense input device of FIG. 7.

FIG. 10 is a sectional view showing a different embodiment of a fingertip tactile-sense input device of the present invention

FIG. 11 is a sectional view showing a different embodiment of a fingertip tactile-sense input device of the present invention

FIG. 12 is a sectional view showing a different embodiment of a fingertip tactile-sense input device of the present invention

FIG. 13 is a sectional view showing a different embodiment of a fingertip tactile-sense input device of the present invention

FIG. 14 is a sectional view showing a different embodiment of a fingertip tactile-sense input device of the present invention

### DESCRIPTION OF THE REFERENCE SYMBOLS

10 Frame
11 Flange
12 Upper case
13 Lower case
20 Surface sheet
21, 22 Surface protrusion
30, 31 Digitizer
32 Flat cable
33 Spacer
40 Actuator
41 Convex part
50 Base plate
51 Dome spring
52 Contact structure
53 Wiring pattern
60, 61 Switch substrate
62 Lower film
63 Upper film
64 Flat cable
70 Composite substrate

### DETAILED DESCRIPTION

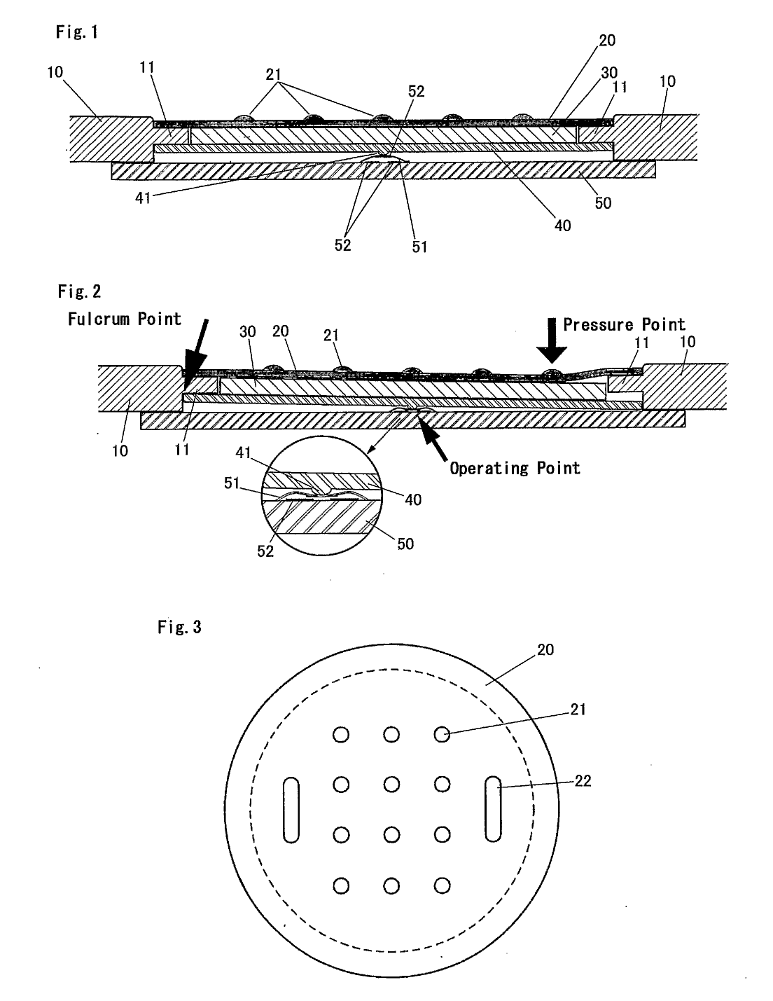

The fingertip tactile-sense input device of the present invention will be described with reference to the drawings. FIG. 1 is a sectional drawing showing an embodiment of a fingertip tactile-sense input device of the present invention. FIG. 2 is a sectional drawing of the fingertip tactile-sense input device of FIG. 1, showing an operational state. FIG. 3 is a design drawing of a surface sheet.

As one embodiment of the fingertip tactile-sense input device of the present invention, there is provided a frame (10), a base plate (50), a surface sheet (20), a digitizer (30), and an actuator (40).

The frame (10) has a hole space opened in the center, and a flange (11) extending from an inner wall surface to the hole space. The frame (10) may be one that is slightly larger than the surface sheet (20), however this may be part of a structure of equipment in which it is used. The opening shape of the hole space of the flange may be circular, oval, or egg shape, or may be an optional shape such as a quadrilateral or multi-angle shape with round corners.

The base plate (50) is fixed to a side on one face of the frame (10), at the periphery of the hole space, and forms a bottom face of the hole space. As the fixing method for the base plate (50), this may be directly bonded, or indirectly attached via another structure by any known technique. One dome spring (51) is arranged at the approximate center of the base plate (50) on the side of the hole space, and has a contact structure (52) on the inside of the dome spring (51). The material of the dome spring (51) is selected from a material with high durability and shock resistance such as a metal or resin. The base plate (50) is made from printed circuit board (PCB), and the contact structure (52) is a printed circuit, and the dome spring (51) may be formed integrally with the base plate (50). The contact structure (52) may be configured with the metal dome spring (51) as one electrode, and one or two other electrodes arranged in a facing position, so that by deforming the dome spring (51) the contact structure transits between a non-conductive state and a conductive state. Moreover, by providing a convex part (41) on the dome spring (51) or the facing structure, a most appropriate click feeling may be obtained.

The base plate (50) may be formed integral with the frame (10). Moreover, it is also possible to form the base plate (50) integral with the frame (10), and make this into one casing, and appropriately provide wiring such as a flat cable (64) for connecting the switch to the outside, and as necessary provide a collar for fixing to the outer peripheral surface of the frame (10), to thereby make a package of the fingertip tactile-sense input device.

The surface sheet (20) is fixed to the flange (11) so that in the free state, this becomes approximately the same level as the other surface of the frame (10), and is provided with a plurality of surface protrusions (21) deployed within a range in which the person's fingertip moves, and is provided with flexibility, elasticity, and pliability. Furthermore, if in addition to the surface protrusions (21) arranged in an array, long surface protrusions (22) as shown in FIG. 3, are arranged on both sides, then the device can be easily operated by the mere touch of a finger.

The digitizer (30) is arranged so as to be slidable on the surface sheet (20), on the hole space side of the surface sheet (20), and is smaller than the outline of the inside of the flange (11), and is capable of electrically measuring a position where a force applied to the surface sheet (20) is the strongest. For the digitizer (30), a resistance film system, a pressure sensitive system, or a capacitance system can be used. The digitizer may be connected by wiring such as a flat cable (32) to the outside.

The actuator (40) is larger than the outline of the inside of the flange (11), and is fixed to the digitizer (30), and has rigidity, and is provided with a convex part (41) which is sized such that in a free state, the contact structure (52) becomes a non-conductive state, and in a state where the surface sheet (20) is pressed by a force of a predetermined amount or more, the dome spring (51) is pressed, and the contact structure (52) becomes a conductive state.

Furthermore, while not shown in the drawing, instead of fixing the dome spring (51) and the contact structure (52) to the base plate (50), they may be fixed to the actuator (40).

For any of the parts and components, it is possible to use known electronic material and electronic components.

The shape and size of these parts and components can be appropriately changed depending on the applicable personal digital assistant, or the size, structure, and application of the compact electronic equipment. However, for all of the structures, by making the thickness as thin as possible, a structure which achieves miniaturization, thinness, and lightening can be obtained.

More specifically, with; a silicone or resin film surface sheet (20) of diameter 32 mm and thickness 0.20 mm, a digitizer (30) of diameter 27.6 mm and thickness 0.3 mm, a stainless steel actuator (40) of diameter 32 mm and thickness 0.2 mm, and a metal or resin dome spring (51) of diameter of 5 mm and height 0.25 mm, the thickness from the surface of the base plate (50) to the surface of the surface sheet (20) is not greater than 1.2 mm, giving an extremely thin fingertip tactile-sense input device. In this case, with the length of the stroke of the dome spring of 0.2 mm or less, a suitable click feeling can be obtained.

The operation of the fingertip tactile-sense input device of the present invention is described with reference to the figures.

In the free state, as shown in FIG. 1, the dome spring (51) is not deformed, and the contact structure (52) is in the non-conductive state.

In a state with the center of the surface sheet (20) pressed by a force of a predetermined amount or more, the convex part (41) deforms the dome spring (51) with the actuator (40) maintained in a parallel state with respect to the base plate (50), so that the contact structure (52) becomes a conductive state.

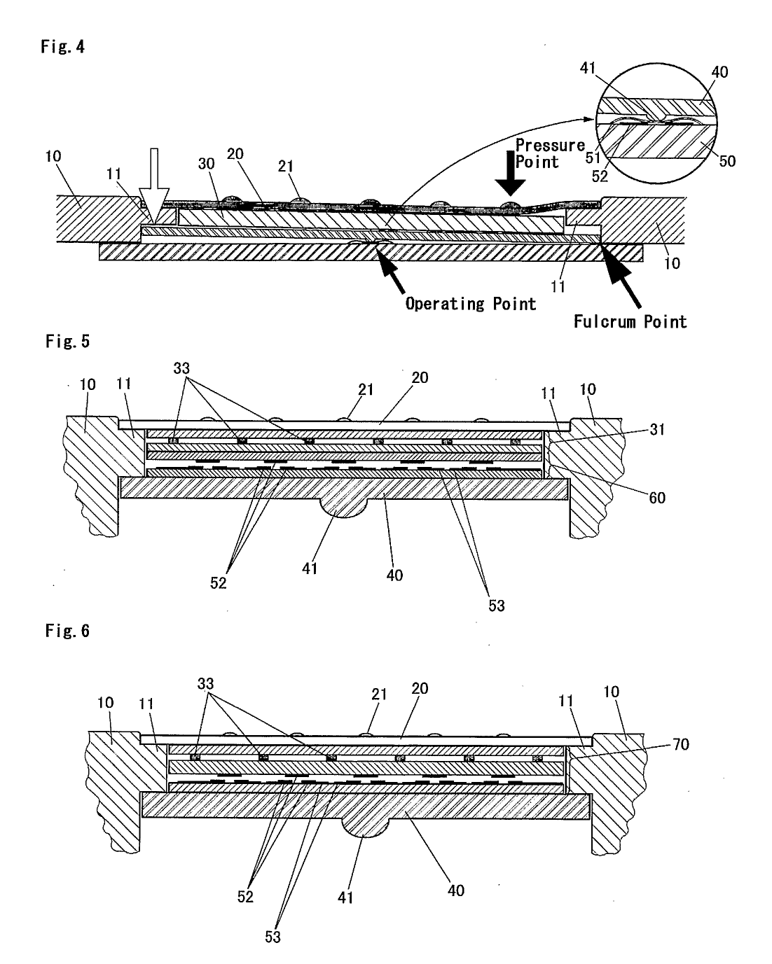

Furthermore, in a state with a part other than the center of the surface sheet (20) pressed by a force of a predetermined amount or more, then as shown in FIG. 2, the pressed position becomes the pressure point, and the position abutted with the flange (11) at the diagonally opposite edge of the actuator (40) becomes the fulcrum point, and the pressing force is transmitted by the principle of levers so that the convex part (41) becomes the operating point, and the dome spring (51) is deformed and the contact structure (52) conducts. Alternatively, as shown in the sectional view of FIG. 4, the pressed position becomes the pressure point, and the position that contacts with the base plate (50) at the edge of the actuator (40) becomes the fulcrum point, and the pressing force is transmitted by the principle of levers so that the convex part (41) becomes the operating point, and the dome spring (51) is deformed and the contact structure (52) conducts. Whether the fulcrum point shown in FIG. 2 or the fulcrum point shown in FIG. 4 becomes the fulcrum point, is determined by the respective positional relationships and the flexibility.

Alternatively, as shown in the sectional view of FIG. 5, a switch substrate (60) having a plurality of contact structures (52) may be arranged between a digitizer (31) and an actuator (40). By having such a structure, then even if an abnormality occurs in the dome spring, loss of the input function can be avoided.

Alternatively, as shown in the sectional view of FIG. 6, a composite substrate (70) may be provided so as to combine the function of a digitizer and a switch substrate. By having such a structure, the number of processes for positional alignment can be further reduced.

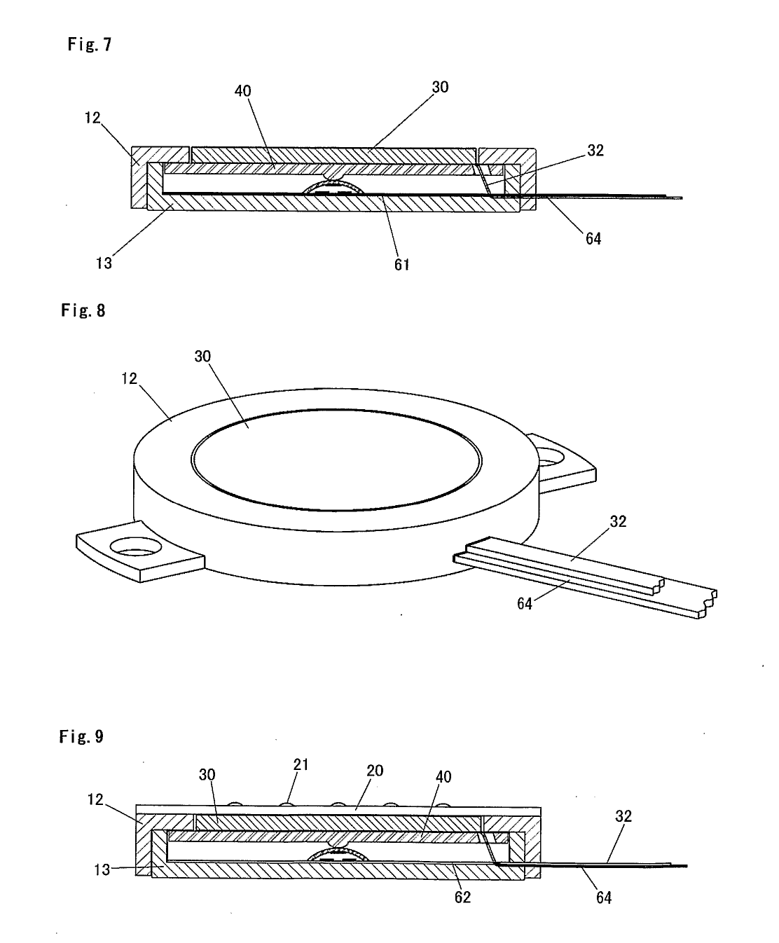

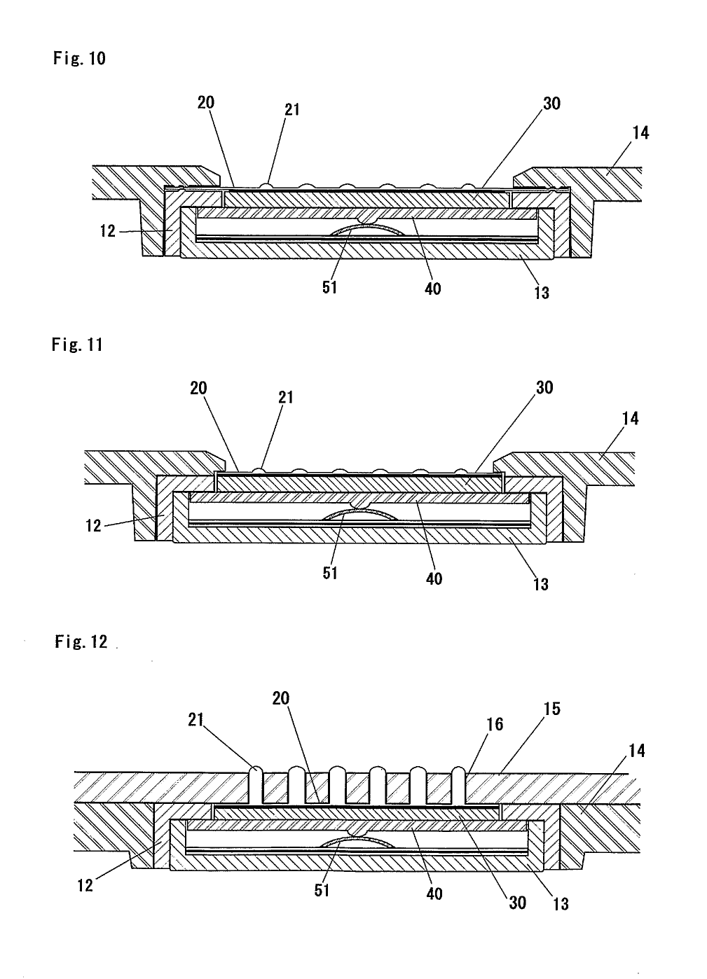

An embodiment where the frame comprises an upper case (12) and a lower case (13), is shown in sectional view in FIG. 7, in perspective view in FIG. 8, and a sectional view in a state where a surface sheet is further placed on top is shown in FIG. 9. In this embodiment, one part of the upper case (12) serves the function of the aforementioned flange, and the obtained fingertip tactile-sense input device can be handled as a stand alone electronic component, so that attachment to a cellular telephone or the like is facilitated.

The present invention is not limited to the best mode, and the examples.

That is to say, at first, the fingertip tactile-sense input device according to the present invention comprises: a frame having a hole space opened in the center, and a flange extending from an inner wall surface to the hole space; a base plate that forms a bottom face of the hole space; a digitizer arranged inside the hole space; a rigid actuator that is fixed to the bottom face side of the digitizer, and in which a periphery thereof is arranged on a bottom face side of the flange; a switch mechanism provided between the base plate and the actuator, in a central portion of the hole space; and a click mechanism provided between the base plate and the actuator, in a central portion of the hole space, which becomes a fulcrum point for operation of the actuator, and is constructed such that in a free state, the switch mechanism is in a non-conductive state, and when the digitizer and the actuator are pressed with a pressing force of a predetermined amount or more in an optional position, the click mechanism operates and the switch mechanism becomes a conductive state. As a result, for example it is no longer necessary to provide respective switches for the input keys provided on the fingertip tactile-sense input device, and is not necessary to provide a click function that imparts a click feeling for each of the input keys. Furthermore, as mentioned above, the actuator can pivot with the click mechanism as the fulcrum point, and it is possible to operate the click mechanism and the switch mechanism by a pressing force of a predetermined amount or more in an optional position of the digitizer within the surface sheet. Therefore there is the point that with only one switch mechanism and one click mechanism for a switch operation in any of the surface positions of the digitizer within the surface sheet, it is possible to correspond to the operations of input, selection, and confirmation of a plurality of input keys having a click feeling.

The switch mechanism and the click mechanism, as mentioned before, are preferably made up from the dome spring (51) and the contact structure (52) provided thereon. However, if there is a switch member of a construction enabling an extremely small stroke of 0.10 mm to 0.30 mm, and which can be substituted from the point of view of durability and a distinct click feeling, then it is possible to replace these with such a switch member. Furthermore, the present invention is characterized by the point that input is possible with one switch corresponding to a plurality of input keys. However an other auxiliary switch may be provided separately.

In the present invention, the main use is in application to an input apparatus in which a plurality of surface protrusions (21) corresponding to keys are provided on the surface of a surface sheet (20), and input, selection, and confirming of the input information is possible by tactile sense of the surface protuberances by the fingertip. However, the invention is not limited to this, and is also applicable to input devices of other forms for small size terminals, in which a plurality of keys are arranged within an extremely small range within which the person's fingertip are movable, and to other types of input devices where a distinct click feeling and input operation is required with only one switch mechanism.

In the above embodiments, the digitizer (30) is fixed to the actuator (40), the surface sheet (20) is fixed to the top of the flame (10), and therefore the internal surface of the surface sheet (20) is arranged so as to be slidable on the top surface of the digitizer (30). However, the surface sheet (20) can be fixed with adhesion to the digitizer (50). The followings are some embodiments having that kind of the structure.

FIG. 10 is a sectional drawing showing an embodiment of a fingertip tactile-sense input device of the present invention. In this embodiment, the internal surface of the operating section of the surface sheet (20) is fixed to the top surface of the digitizer (30), and the outer circumference section of the surface sheet (20) is fixed by and between the top of the upper case (12) and the inferior surface of the product's case (14).

FIG. 11 is a sectional drawing showing an embodiment of a fingertip tactile-sense input device of the present invention. In this embodiment, the surface sheet (20) having the approximately same size as the outer shape of the digitizer (30) is fixed to the upper surface of the digitizer (30), and they are fixed by pressing them from the interior side to the interior surface of the outer circumference of the product's case having an opening which is smaller than the outer shape of the digitizer (30) and larger than the operating section of the surface sheet (20).

FIG. 12 is a sectional drawing showing an embodiment of a fingertip tactile-sense input device of the present invention. In this embodiment, the surface sheet (20) having the approximately same size as the outer shape of the digitizer (30) is fixed to the upper surface of the digitizer (30), and the protrusions of the surface sheet (20) are formed so as to be 1 mm or more in height. Moreover, the through holes (16) are formed in the ornamental panel (15) of the product in accordance with the protrusions (21, 22) so that the protrusions (21, 22) project by about 0.1 mm to 0.5 mm from the upper surface of the ornamental panel (15). In this way, the device does not come to the top of the product and the upper side of the device is covered by the ornamental panel (15) and only the protrusions (21, 22) appear from the surface of the product.

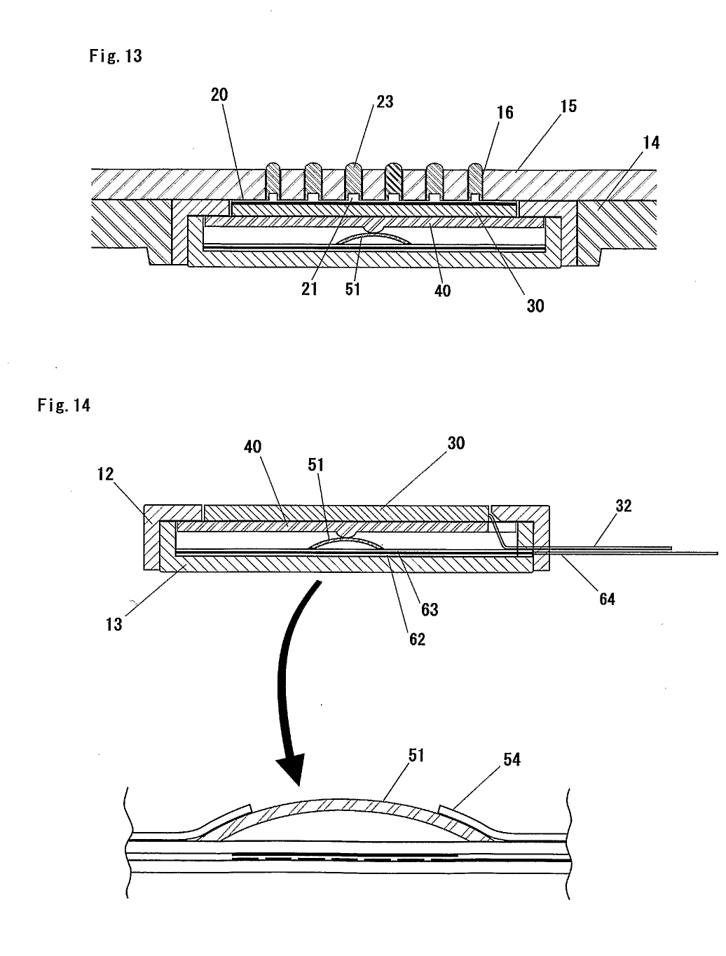

FIG. 13 is a sectional drawing showing an embodiment of a fingertip tactile-sense input device of the present invention. In this embodiment, unlike in the embodiment shown in FIG. 12, the sections which raise the height of the protrusions are replaced by the separate caps (23). The respective caps are fitted onto the corresponding protrusions (21) formed on the surface sheet (20). With the configuration where the section which function as protrusion is divided into the two elements, separate from the flexible, stretchable, and pliable surface sheet (20), the rigid material such as metal and metal coated plastic can be easily applied as keys using protrusions. In this way, a variety of designs can be applied to the product.

FIG. 14 is a sectional drawing showing an embodiment of a fingertip tactile-sense input device of the present invention. This embodiment differs in contact structure from the embodiments shown in FIGS. 1 through 9. The switch mechanism of this embodiment comprises a upper film (63) and a lower film (62; film substrate) respectively provided with a printed pattern. In the free state, the contact pattern which is printed on the lower film (62) is in the non-conduction state. This contact pattern may be connected to the outside by a flat cable (64). The dome spring (51) is placed on and fixed to the upper surface of the upper film by a fixing film (54) for the dome spring, so that the contact pattern of the lower film (62) becomes in the conduction state by a pattern for conduction which is printed on the inferior surface of the upper film (63) when the dome spring (51) is pressed. By this configuration, the durability of the device can be enhanced. In the embodiments shown in FIGS. 10 through 13, the devices are depicted as adapting the same contact structure as in FIG. 14. However, the other structures may be adapted in these embodiments.

1. A fingertip tactile-sense input device comprising:
a frame having a hole space opened in the center, and a flange extending from an inner wall surface to the hole space;
a base plate which is fixed at a peripheral portion of the hole space, to a side of one face of the frame, or is formed integral with the frame, and forms a bottom face of the hole space;
a digitizer arranged inside the hole space, that is smaller than an outline of an inner periphery of the flange, and which can electrically measure an input position by pressure applied to the surface thereof;
a rigid actuator that is larger than the outline of the inner periphery of the flange, and is fixed to a bottom face side of the digitizer, and in which a periphery thereof is arranged on a bottom face side of the flange;
a switch mechanism provided between the base plate and the actuator, in a central portion of the hole space; and
a click mechanism provided between the base plate and the actuator, in a central portion of the hole space, which becomes a fulcrum point for operation of the actuator,
and in a free state, the switch mechanism is in a non-conductive state, and when the digitizer and the actuator are pressed with a pressing force of a predetermined amount or more in an optional position, the click mechanism operates and the switch mechanism becomes a conductive state.

2. A fingertip tactile-sense input device according to claim 1, further having a surface sheet on a side of an Other face of the frame, and arranged to cover a surface side of the hole space, and to be slidable on the digitizer.

3. A fingertip tactile-sense input device according to claim 2, wherein a plurality of surface protrusions corresponding to keys, are provided on a surface of the surface sheet.

4. A fingertip tactile-sense input device according to either one of claim 2 and claim 3, wherein the hole space is sealed to be waterproof, drip-proof, or airtight, by the frame, the base plate, and the surface sheet.

5. A fingertip tactile-sense input device according to any one of claim 1 through claim 4, wherein the switch mechanism and the click mechanism comprise: a dome spring provided on an approximate center of either one of the base plate and the actuator, and having a contact mechanism inside; and a convex part provided on an approximate center of the other of either one of the base plate and the actuator, and in a free state, the contact structure becomes a non-conductive state, and when the actuator is pressed with a pressing force of a predetermined amount or more in an optional position, the dome spring imparts a click feeling, and the contact structure becomes a conductive state.

6. A fingertip tactile-sense input device according to claim 5, wherein a stroke range of the dome spring is 0.10 mm to 0.30 mm.

7. A fingertip tactile-sense input device comprising:
a frame having a hole space opened in the center, and a flange extending from an inner wall surface to the hole space;
a base plate which is fixed at a peripheral portion of the hole space, to a side of one face of the frame, and which has one dome spring arranged at an approximate center of a side of the hole space, and a contact structure in the interior of the dome spring;
a flexible, stretchable, and pliable surface sheet fixed to the flange so that in a free state it becomes approximately the same level as an other face of the frame, and provided with a plurality of surface protrusions deployed within a range in which a person's fingertip moves;
a digitizer arranged to a side of the hole space from the surface sheet, and slidable on the surface sheet, that is smaller than an outline of an inside of the flange, and that is capable of electrically measuring a position where a force applied to the surface sheet is strongest; and
a rigid actuator provided with a convex part that is dimensioned such that in a free state the contact structure is non-conductive, and in a state where the surface sheet is pressed, the dome spring is pressed, and the contact structure becomes conductive, and that is larger than the outline of the inside of the flange, and is fixed to the digitizer.

8. A fingertip tactile-sense input device comprising:
a frame having a hole space opened in the center, and a flange extending from an inner wall surface to the hole space;
a base plate which is fixed at a periphery of the hole space, to a side of one face of the frame;
a flexible, stretchable, and pliable surface sheet fixed to the flange so that in a free state it becomes approximately the same level as an other face of the frame, and provided with a plurality of surface protrusions deployed within a range in which a person's fingertip moves;
a digitizer arranged to a side of the hole space from the surface sheet, and slidable on the surface sheet, that is smaller than an outline of an inside of the flange, and that is capable of electrically measuring a position where a force applied to the surface sheet is strongest; and
a rigid actuator that is larger than the outline of the inside of the flange, and is fixed to the digitizer,
and one dome spring is arranged at an approximate center of the actuator on a side of the base plate, and an interior of the dome spring has a contact structure, and on a center of the dome spring or on a center of the base plate there is provided a convex part that is dimensioned such that in a free state the contact structure is non-conductive, and in a state where the surface sheet is pressed, the dome spring is pressed, and the contact structure becomes conductive.

9. A fingertip tactile-sense input device comprising:
a frame having a hole space opened in the center, and a flange extending from an inner wall surface to the hole space;
a base plate which is fixed at a periphery of the hole space, to side of one face of the frame;
a flexible, stretchable, and pliable surface sheet fixed to the flange so that in a free state it becomes approximately the same level as an other face of the frame, and provided with a plurality of surface protrusions deployed within a range in which a person's fingertip moves;
a digitizer arranged to a side of the hole space from the surface sheet, and slidable on the surface sheet, that is smaller than an outline of an inside of the flange, and that is capable of electrically measuring a position where a force applied to the surface sheet is strongest; and
a rigid actuator that is larger than the outline of the inside of the flange, and is fixed to the digitizer,
and one dome spring is arranged, at an approximate center of the actuator on a side of the base plate, or at an approximate center of the base plate on a side of the actuator, and has a contact structure between the digitizer and the actuator.

10. A fingertip tactile-sense input device wherein a hole space is formed by enclosing within; a flexible, stretchable, and pliable surface sheet comprising a plurality of surface protrusions deployed within a range in which a person's fingertip can move, a frame, and a base plate parallel to the surface sheet, and in the hole space is arranged a digitizer slidable on the surface sheet, and that is capable of electrically measuring a position where a force applied to the surface sheet is strongest, and a rigid actuator fixed to a side of the base plate from the digitizer, and a contact structure which is dimensioned so as to become a non-conductive state in a free state, and to become a conductive state in a state where the surface sheet is pressed, and a dome spring, are positioned between the actuator and the base plate.
